(19) United States
(12) Patent Application Publication
(10) Pub. No.: US 2011/0039625 A1
(43) Pub. Date: Feb. 17, 2011

(54) Game Control Program, Game Device, And Method For Controlling Game

(75) Inventors: Kenji SAKAI, Tokyo (JP); Akira Takeuchi, Tokyo (JP)

Correspondence Address: GIBSON & DERNIER LLP, 900 ROUTE 9 NORTH, SUITE 504, WOODBRIDGE, NJ, 07095, US

(73) Assignee: Sony Computer Entertainment Inc., Tokyo (JP)

(21) Appl. No.: 12/853,383

(22) Filed: Aug. 10, 2010

(30) Foreign Application Priority Data
Aug. 14, 2009 (JP) 2009-188154

(51) Int. Cl. G06F 17/00

(52) U.S. Cl. 463/43; 463/1

(57) ABSTRACT

A game device comprising: a roll control unit or a slide control unit operative to allow a character to move on a game field; a jump control unit operative, upon receiving an input operation for allowing the character to jump while the first requirement is satisfied, to allow the character to jump and to change a mode of a game to a special mode where a reward is given to a player; an acceleration control unit operative, upon receiving an input operation for accelerating the character while the second requirement is satisfied, to accelerate the character and to change a mode of a game to a special mode where a reward is given to a player; a combo control unit operative, if no input operation for all owing the character to jump is received while the first requirement is satisfied and no input operation for accelerating the character is received while the second requirement is satisfied, to terminate the special mode and to give a reward to a player in the special mode.

### BACKGROUND OF THE INVENTION

1. Field of the Invention

The present invention relates to technology for controlling games, and more particularly, to game devices for controlling a game where a character is moved and led to a goal, methods for controlling the game, and a program for controlling the game.

2. Description of the Related Art

### BACKGROUND TECHNOLOGY

A number of games are provided, where a character is moved and led to a goal on a game field where items, obstacles, etc., are disposed. A player inputs an operation for allowing a character to move, jump, accelerate, etc., so as to control the motion of the character.

### SUMMARY OF THE INVENTION

The present inventor attained an idea on technology for modifying such a game system and implementing a highly-developed game with a higher enjoyment level. In this background, a purpose of the present invention is to provide technology for implementing a game device having a higher enjoyment level.

According to one embodiment of the present invention, a program embedded in a computer readable medium is provided. The program comprises: a movement module operative to allow a character to move on a game field; a lump module operative to receive an input operation for allowing the character to jump and to allow the character to jump; an acceleration module operative to receive an input operation for accelerating the character while the character is moving and to accelerate the character in the moving direction; a jump-and-change-mode module operative, after accelerating the character or after allowing the character to jump, if receiving an input operation for allowing the character to jump while a first requirement is satisfied, to allow the character to jump and to change a mode of a game to a special mode where a reward is given to a player; an accelerate-and-change-mode module operative, after accelerating the character or after allowing the character to lump, if receiving an input operation for accelerating the character while a second requirement is satisfied, to accelerate the character and to change the mode of a game to the special mode where a reward is given to a player; a terminate module operative, if no input operation for allowing the character to lump is received while the first requirement is satisfied and if no input operation for accelerating the character is received while the second requirement is satisfied, to terminate the special mode; and a reward-giving module operative to give a reward to the player in the special mode.

### BRIEF DESCRIPTION OF THE DRAWINGS

FIG. 1 shows a structure of a game device according to an embodiment;

FIG. 2A-E show a general outline of a game;

FIG. 3 shows an exemplary screen image of the game;

FIG. 4 shows another exemplary screen image of the game;

FIG. 5 shows a control point for controlling the shape of a character;

FIG. 6 shows a control point for controlling the rolling movement of a character;

FIG. 7 shows another exemplary screen image of the game;

FIG. 8 shows another exemplary screen image of the game; and

FIG. 9 shows another exemplary screen image of the game.

### DETAILED DESCRIPTION OF THE INVENTION

The invention will, now be described by reference to the preferred embodiments. This does not intend to limit the scope of the present invention, but to exemplify the invention.

A game device according to the present embodiment provides a game where a character is moved and led to a goal on a game field. As one example of a method for moving characters, the game device according to the present embodiment allows a character, on a game field including vertical land features, to roll in a desired direction by allowing a player to tilt the ground with which the character has contact. A character is not only moved passively by being rolled by the gradient of the ground but is also able to move actively by its own apparent thought will, based on artificial intelligence.

Besides the operation for tilting the ground, a player can execute an operation for flipping a character by using the ground or a wall, so that the character jumps. Further, when a character is moving by sliding on the ground, a user can execute an operation for accelerating the character. In this fashion, a player targets a goal with the cooperation of the character while indirectly allowing the character to move, jump, accelerate, etc., by operating the gradient of the ground.

According to the present embodiment, when a player succeeds in multiple jumps or accelerations in a row, the player receives a reward such as a point or the like. A reward is given to a player not only when there are successful consecutive tamps or consecutive accelerations but also when a combination of multiple jumps and accelerations are performed in a row. Therefore, a player can gain a reward by executing an appropriate operation according to the land features and allowing a character to jump, accelerate, or the like, so as to allow the character to move. Further, since continuous operation needs to be performed at an appropriate time in order to succeed in consecutive jumps or accelerations, the enjoyment of proceeding with a game with rhythmic play at a good pace can be provided.

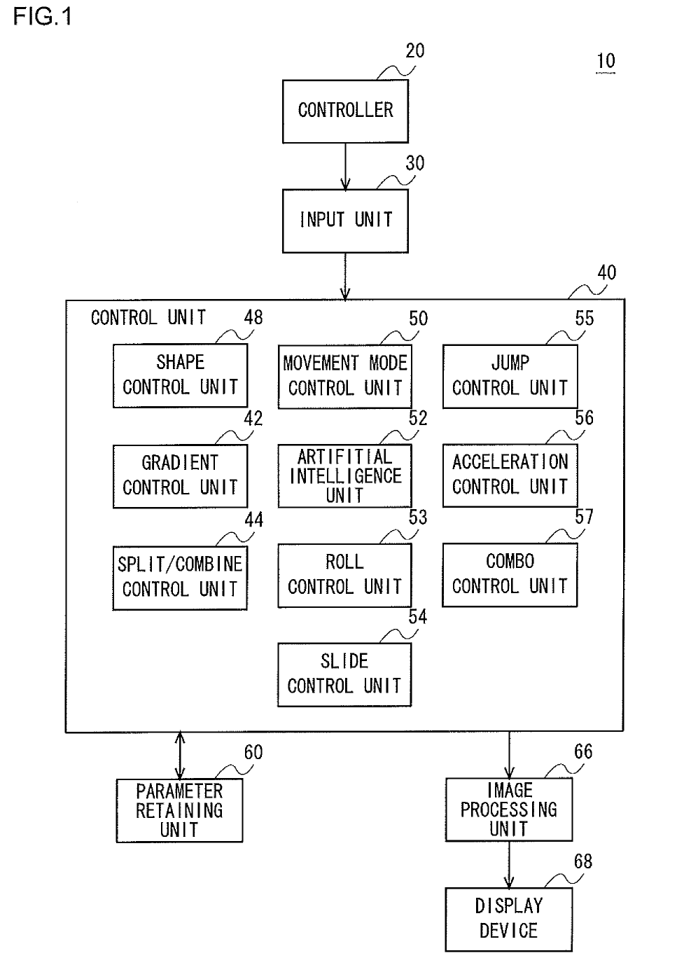

FIG. 1 shows a structure of a game device 10 according to the present embodiment. The game device 10 comprises a controller 20, an input unit 30, a control unit 40, a parameter retaining unit 60, an image processing unit 66, and a display device 68. These blocks may be implemented, in terms of hardware components, by elements such as a CPU of a computer, memory, a program loaded onto memory, or the like. FIG. 1 depicts functional blocks implemented by cooperation of these blocks. Therefore, it will be obvious to those skilled in the art that the functional blocks may be implemented in a variety of manners by a combination of hardware and software.

The input unit 30 receives control signals input from the controller 20 that is operated by a player. The control unit 40, based on the instruction by the user received by the input unit 30, executes a game program that is read out from a recording mediums (not shown) and makes the game progress. The parameter retaining unit 60 retains parameters representing attributes of a character, parameters set for land features, such as ground, walls, etc. The image processing unit 66 generates a screen image of the game, the screen image being controlled by the control unit, and allows the display device 68 to display the screen image. The details on the operation of respective structures will be given in the following explanation.

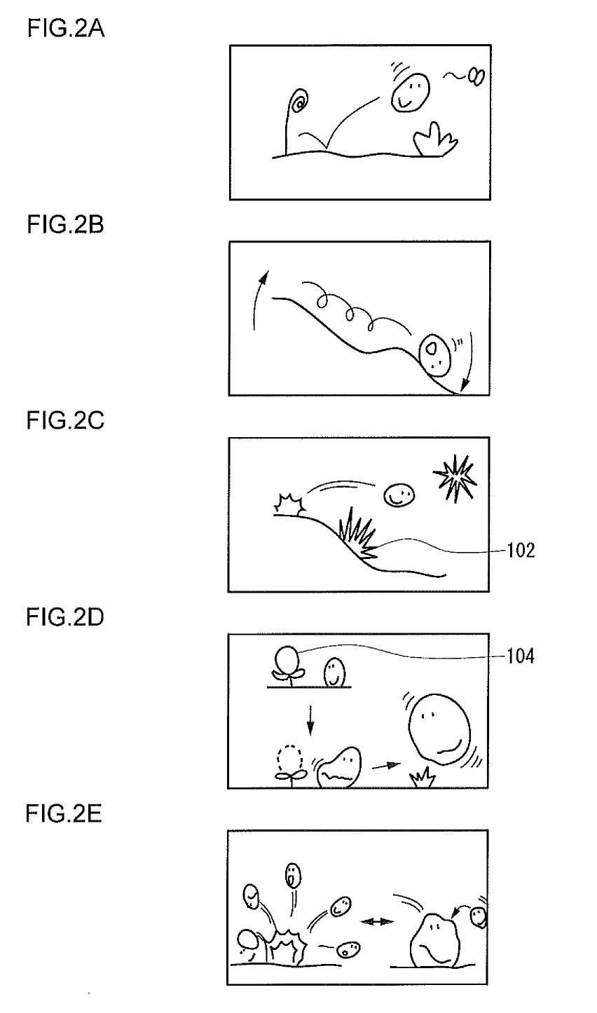

FIGS. 2A-E show a general outline of the game. FIG. 2A shows an appearance where a character acts autonomously. In the example of FIG. 2A, the character has found a butterfly, moves while jumping, and follows the butterfly. This independent mode where a character acts independently based on the character's own apparent thought is controlled by an artificial intelligence unit 52.

FIG. 2B shows an appearance where a player tilts the ground below a character. As the player adds a gradient to the ground by rotating clockwise via the controller 20, the character rolls from the left side to the right, side of the screen along the gradient. This rolling mode, where a character cannot withstand the effect of the inclination of the ground and rolls, is controlled by a roll control unit 53. A slide mode, where a character slides on a slippery ground having a small dynamic friction coefficient, is controlled by a slide control unit 54. The gradient control unit 42 receives an operation on the gradient of the ground that is input by a player via the controller 20 and controls the gradient angle of the ground. The roll control unit 53 and the slide control unit 54 execute a physical calculation based on the gradient angle of the ground and control the motion of character so that the character rolls or slides on the ground. This allows a player to indirectly operate a character that moves around freely and arbitrarily based on its artificial intelligence, by giving a gradient to the ground.

FIG. 2C shows an appearance where a player flips a character by the ground below the character and allows the character to jump. A player flips by using the ground via the controller 20, and the character jumps, accordingly. Although a character can lump according to its own will as controlled by the artificial intelligence unit 52, the character sometimes jumps because the player flips it as shown in FIG. 2C. The movement of a character when flipped by a player is controlled by a lump control unit 55. The lump control unit 55 executes a physical calculation based on the strength of the flip which is given to the character by the player, the gradient angle of the ground, the frictional force working between the ground and the character, etc., and controls the character so that the flip from the ground makes the character jump. If there exists an obstacle, such as thorns 102 or the like, the player can allow the character to jump so as to avoid the obstacle.

FIG. 2D shows an appearance where a player acquires a character-multiplication item. Since a character has eaten a piece of fruit 104, which is the character-multiplication item, the number of characters increases and the size of the body becomes large. Although in FIG. 2D, a plurality of characters are combined into one, it is also possible to allow the characters to break up and to move as separate characters.

FIG. 2E shows an appearance where characters break up and combine together. If the number of characters increases and more than one character exists, those characters can be combined together or can be split. The split and combination of the characters are controlled by a split/combine control unit 44. A player can instruct for splitting or combining via the controller 20. Alternatively, the characters can split or combine at their own will. Further, if the combined body of characters receives an impact at more than a predetermined level, for example, when characters bump into the thorns 102 or the like, fall from a high place, etc., up to several characters split from the body of combined characters. The number of characters that split is determined by the split/combine control unit 4 according to the number of characters, the vitality level of the characters, or the like.

An explanation on the structure of each element will be continued while referring back to FIG. 1. The gradient control unit 42 receives an operation input, by a player via the controller 20 and controls the gradient angle of the ground on a game field. For example, an operation for lowering the ground at its right side in the screen may be allocated to a button disposed at the right side of the controller 20, and an operation for lowering the ground at its left side in the screen may be allocated to a button disposed at the left side of the controller 20. This allows a player to input an operation on the gradient of the ground, where the operation can be understood intuitively. Alternatively, a sensor for detecting the inclination of the controller 20 may be provided, and tilting the controller 20 itself may lead to an instruction for an operation on the gradient of the ground, and the operation may be received and may be reflected to the game field. The gradient control unit 42 calculates the current gradient angle of the ground and notifies a movement mode control unit 50, the roll control unit 53, the slide control unit 54, etc., thereof. The gradient control unit 42 may only add a gradient to the ground below the character, or may add a gradient to the whole game field.

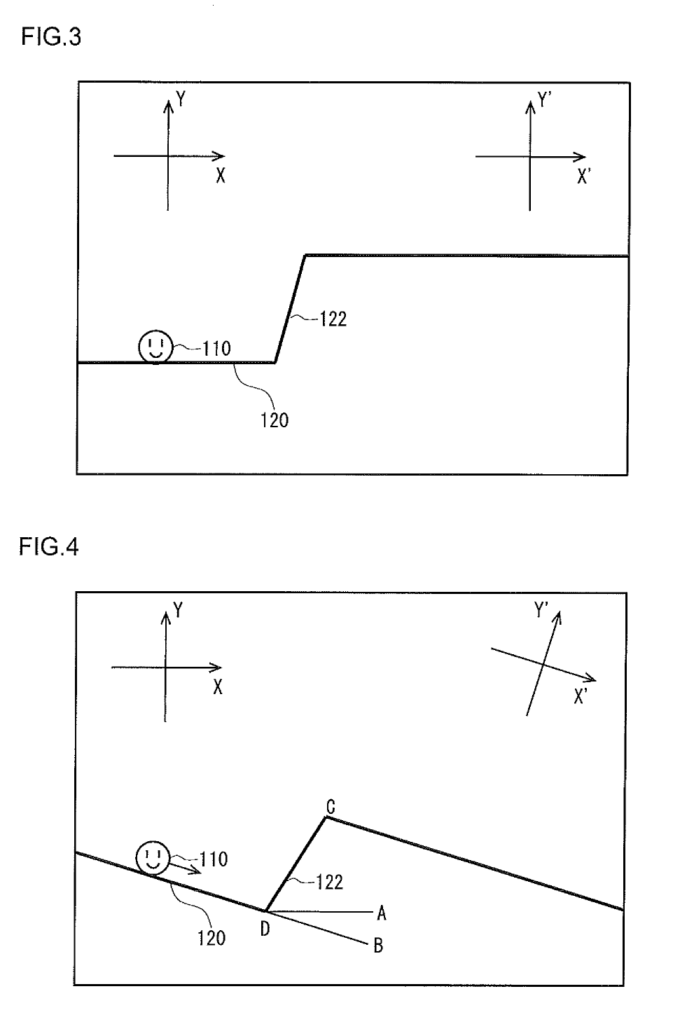

FIG. 3 shows an exemplary screen image of the game. On the game screen image, a game field, including the ground surface 120 and a wall 122, and a character 110 are displayed. If a player inputs a button disposed on the right side of the controller 20 while the came screen shown in FIG. 3 is displayed, the gradient control unit 42 adds a gradient to the whole game field so that the ground at the right side of the screen becomes low, as shown in FIG. 4. At this point, the ground surface 120, with which the character 110 has contact, is horizontal on the X′-Y′ coordinate system, which is a local coordinate system, but has gradient so the right side is low in the X-Y coordinate system, which is she world coordinate system in the game screen image. Thus, the character moves so as to roll to the right side. The gradient angle of the wall 122 is angle BDC and remains constant in the local coordinate system, but in the world coordinate system, the gradient angle of the wall 122 becomes angle ADC in accordance with the gradient of the whole game field. Hereinafter, when differentiating between these angles, a gradient angle in the local coordinate system is referred to as a “relative gradient angle” and a gradient angle in the world coordinate system is referred to as an “absolute gradient angle.”

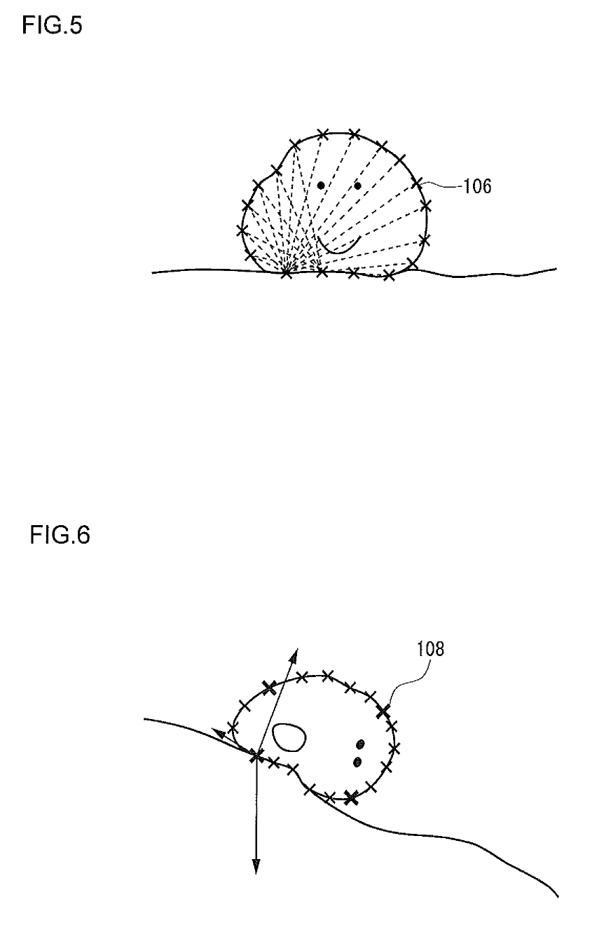

A shape control unit 48 calculates the shape of the character based on a physical calculation. The shape control unit 48, as shown in FIG. 5, represents the outer edge of the body of the character by connecting a predetermined number (e.g., thirty-two) of control points 106. The shape control unit 48 connects respective control points 106 with virtual springs. By calculating respective positions of the control points 106 based on the elastic force of the springs, the shape control unit 48 represents the jelly-like configuration of the body. By adjusting the spring constant of the virtual springs that connect the control points 106, the pliability of the shape of the body can be changed. For example, when the character is in a rolling mode and rolls down a slope, the springs may be set to be stiffer as the rotating speed increases so that the character can easily roll. This enables the easy acceleration of the character, and therefore the operability can be improved. Meanwhile, at a location where the character is required so flip and the character is allowed to jump, the springs may be set to be softer so that the character can be easily flipped. In this manner, by adjusting the spring constant so as to adjust the pliability of the body, the operability or difficulty level of the game can be altered. Further, it enables the representation of a jelly-like tactile impression and enables the user to be given a “healing” effect. A variety of gimmicks disposed on a game field may also be presented so that the gimmicks move lambently by using physical calculations.

The split/combine control unit 44 controls the splitting and the combining of characters. As described above, the number of characters increases, for example, when a character acquires a character multiplication item or the like. A plurality of characters can combine together and behave as one body or can split and behave as separate bodies. Upon receiving the instruction on the operation of the splitting or combination from a user via the controller 20, the split/combine control unit 44 allows the character to split or to combine. When the characters are combined, its movement is controlled as a movement, of one character by the artificial intelligence unit 52, the roll control unit 53, the slide control unit 54, the jump control unit 55, and an acceleration control unit 56. When characters are split, the respective characters are controlled independently.

At an independent mode, the artificial intelligence unit 52 reads out the vitality level of a character from the parameter retaining unit 60 and determines the movement of the character according to the vitality level. In case a plurality of characters exists and the characters are split, the behavior of the respective characters are determined separately by the artificial intelligence unit 52. In case the plurality of characters is combined, one of the characters included in the combined, characters behaves as a representative of the characters.

The movement mode control unit 50 controls the movement mode of a character. The movement mode control unit 50 sets an absolute gradient angle at which a character starts to roll or starts to slide, and if the absolute gradient angle of the ground is smaller than the set absolute gradient angle, the artificial intelligence unit 52 is allowed to control the motion of the character. The movement mode control unit 50 may set, in advance, the absolute angle at which a character starts to roll or starts to slide. Alternatively, the movement mode control unit. 50 may calculate the absolute angle at which a character starts to roll or starts to slide based on the weight of the character, the absolute gradient angle of the ground below the character, the static friction coefficient of the ground below the character, or the like. If the absolute gradient angle of the ground below the character, by an operation by a player or by the movement of the character itself, surpasses the set absolute gradient angle, the movement mode control unit 50 allows the roll control unit 53 or the slide control unit 54 to control the movement of the character. In case the dynamic friction coefficient of the ground below the character is set to a value greater than or equal to a predetermined value, or in case an attribute, indicating that a character moves while rolling on the ground, is set to the ground below the character, the movement mode control unit 50 allows the roll control unit 53 to control the movement of the character. In case the dynamic friction coefficient of the ground below the character is set to be less than or equal to the a predetermined value, or in case an attribute, indicating that a character moves non by rolling on the ground but by sliding on the ground, is set to the ground below the character, the movement mode control unit 50 allows the slide control unit 54 to control the movement of the character. When the roll control unit 53 or the slide control unit 54 controls the movement of a character, if the moving velocity of the characters is less than or equal to a predetermined value, the movement mode control unit 50 allows the artificial intelligence unit 52 to control the motion of the character. When the controller is passed from the roll control unit 53 or the slide control unit 54 to the artificial intelligence unit 52, the appearance of the character getting up may be displayed.

Upon receiving an operation input by a player, to which a function for allowing a character to jump is allocated, the movement mode control unit 50 acquires an attribute of the ground with which the character has contact from the parameter retaining unit 60. If the attribute indicates that it is possible to allow the character to jump, the movement mode control unit 50 allows the jump control unit 55 to control the motion of the character. Upon receiving an operation input by a user, to which a function for allowing a character to accelerate is allocated, the movement mode control unit 50 acquires an attribute of the around, with which the character has contact, from the parameter retaining unit 60, if the attribute indicates that it As possible no accelerate the character, the movement mode control unit 50 allows the acceleration control unit 56 to control the motion of the character.

Generally, an attribute for accelerating a character is set to the ground having a small dynamic friction coefficient on which a character moves while sliding, and an attribute for allowing the character to lump is set to the ground having a large dynamic friction coefficient on which a character moves while rolling. Therefore, when the artificial intelligence unit 52 or the roll control unit 53 controls the motion of a character, it is possible to allow the character to lump, and, when the slide control unit 54 controls the motion of the character, it is possible to accelerate the character. Even on the ground on which the character moves while rolling, in case a passage wherein the character moves through is narrow, whereupon the character is not able to jump in the situation, an attribute for accelerating a character may be set to the ground. In this case, the movement mode control unit 50, upon receiving an input operation for allowing the character to jump, may allow the acceleration control unit 56 to accelerate the character.

The input operation for allowing the character to jump and the input operation for accelerating the character may be the same input operation. In this case, the movement mode control unit 50 determines whether to allow the character to jump or to accelerate the character, in accordance with the attribute of the ground or the wall with which the character has contact

The roll control unit 53, in case the absolute gradient angle of the ground is larger than a predetermined value, allows a character to move as if it rolls on the ground. The roll control unit 53 may calculate the moving velocity of the character based on the weight of the character, the absolute gradient angle of the ground, the dynamic friction coefficient of the ground, or the like, and may move the character. The roll control unit 53 may extract several control points 106 (e.g., four control points 108 as shown in FIG. 6). And then the roll control unit 53 may calculate a velocity vector based on the physical calculation by allowing the following to act on these points: a) the force of gravity due to the weight of the character; b) the normal force by the ground; and c) the dynamic friction force from the ground. This enables the representation of an appearance where the character rolls down on the ground while rotating.

The slide control unit 54, in case the absolute gradient angle of the ground is larger than a predetermined value, allows a character to move as if it slides on the ground. The slide control unit 54 may calculate the moving velocity of the character based on the weight of the character, the absolute gradient angle of the ground, the dynamic friction coefficient of the ground, or the like, and may move the character.

The jump control unit 55, upon receiving an operation input by a player for allowing a character to jump, flips the character by the ground and allows the character to jump. After having allowed the character to jump or after having accelerated the character, if the jump control unit 55 receives an input operation for allowing the character to jump while a first requirement is satisfied, the jump control unit 55 allows the character to jump again. Such types of jumps are referred to as “consecutive jumps”. In this process, the jump control unit 55 may give a larger initial velocity to the character so that the character can jump higher than the height of normal jumps. Upon succeeding consecutive jumps, the jump control unit 55 alters the mode of a game to a special mode where a reward is given to the player. After the character gets down on the ground, the movement mode control unit 50 passes the control to the roll control unit 53 or the slide control unit 54 in accordance with the attribute of she ground on which the character got down.

According to the present exemplary embodiment, after having allowed the character to jump, if the jump control unit 55 again receives an input operation for allowing the character to jump within a predetermined time period after the character got on the ground from the previous jump and while a parameter indicating the level of contact between the character and the ground is equal to or larger than a predetermined value, the jump control unit 55 allows the character to jump again and changes the mode of the game to a special mode. Further, in case the ground or a wall has a slippery attribute when the character gets down on the ground or the wall, if the jump control unit 55 receives an input operation for allowing the character to accelerate while the character is moving at an velocity greater than or equal to a predetermined value, the jump control unit accelerates the character and the mode is changed to a special mode. Also in case the ground or a wall has an attribute for allowing a character to roll when the character gets down on the ground or the wall, if the jump control unit 55 receives an input operation for allowing the character to jump while the character is moving at a velocity equal to or greater than a predetermined value, the jump control unit 55 may allow the character to jump again and may change the mode so a special mode.

The jump control unit 55 may set the following requirements as the first requirements. That is: a) an operation is received within a predetermined period of time after a character contacts the ground; b) a parameter indicating the level of contact between the character and the ground (e.g., the number of vertices that have contact with the ground) is equal to or treater than a predetermined value; c) a character is moving on the ground or a wall of which the absolute gradient angle or the relative gradient angle is equal to or greater than a predetermined value (for example, the character moves as if it rolls or as if it slides); or d) a character moves at a speed equal so or greater than a predetermined value. The jump control unit 55 may set one of the above requirements as the first requirement or may set any combination of the above requirements as the first requirements.

The jump control unit 55, when succeeded in consecutive jumps, may acquire the number of vertices that contact the ground or a wall and may increase the initial speed of jumping as the number of vertices that have contact with the ground or the wall increases.

While the mode of the parse is in a special mode due to a success in consecutive jumps, and when a character has contact with a wall of which the absolute gradient angle or the relative gradient angle is equal to or treater than 60 degrees, and if an operation input by a player for allowing the character to jump is received, the jump control unit 55 flips the character by the wall and allows the character to jump. This type of jump is referred to as a “wall jump.” Unless the mode of the game is in the special mode, the jump control unit 55 does not allow the character to jump even if the jump control unit 55 receives an operation input by a player for jumping when the character has contact with a wall. The jump control unit 55 may move the character in the direction of the normal line of the wall. Alternatively, the jump control unit 55 may allow the character to move to the upper side of the normal line of the wall so that the character can go up, for example, by flipping on both left side wail and right side wall alternately. When the character has contact with a wall, if no operation for jumping input by a player is received, the movement of the character is controlled by the roll control unit 53 or the slide control unit 51 in accordance with the attribute given to the wail or in accordance with the dynamic friction coefficient of the wall.

The acceleration control unit 56, upon receiving an operation input by a player for accelerating a character, accelerates the character in the direction of movement. After having accelerated the character or having allowed the character so jump, if the acceleration control unit 56 receives an input operation for accelerating the character while a second requirement is satisfied, the acceleration control unit 56 accelerates the character in the moving direction again. Such types of accelerations are referred to as “consecutive accelerations.” In this process, the acceleration control unit 56 may make the acceleration greater than the normal level of acceleration. Upon succeeding consecutive accelerations, the acceleration control unit 56 changes the mode of the game to a special mode where a reward is given to the player. After the acceleration control unit 56 accelerates the character, the movement mode control unit 50 passes the control to the roll control unit 53 or the slide control unit 54 in accordance with the attribute of the ground with which the character has contact.

According to the present exemplary embodiment, after having accelerated the character, if the acceleration control unit 56 receives an input operation for accelerating the character while the character slides at a speed equal to or larger than a predetermined value, the acceleration control unit 56 accelerates the character again and changes the mode to the special mode. In addition, after having accelerated the character, if the acceleration control unit 56 receives an input operation for allowing the character to jump or for accelerating the character, while the character is rolling at a speed equal to or larger than a predetermined value, the acceleration control unit 56 may allow the character to jump or may accelerate the character, and the mode may change to the special mode.

The acceleration control unit 56 may set the following requirements as the second requirements for succeeding in the consecutive accelerations. That is: a) a character is moving on the ground or a wall of which the absolute gradient angle or the relative gradient angle is equal to or greater than a predetermined value (for example, the character moves as if it rolls or as if it slides); or b) a character moves at a speed equal to or greater than a predetermined value. The acceleration control unit 56 may set one of the above requirements as the second requirement, or may set any combination of the above requirements as the second requirement.

A combo control unit 57 counts the number of successful consecutive jumps or consecutive accelerations and gives a reward to a player in accordance with the consecutive success number. The combo control unit 57 may increment the consecutive success number also when the character is flipped by a wall and jumps under the control of the jump control unit 55. The combo control unit 57 may increase the score indicating the achievement level of the game in accordance with the consecutive success number. Further, while in the special mode, the combo control unit 57 may increase the number of items disposed on a game field, may make the acquisition of items easier, may enhance the effect of items, etc.

If the combo control unit 57 receives no input operation for allowing a character to jump while the first requirement is satisfied and receives no input operation for accelerating a character while the second requirement is satisfied, the combo control unit 57 terminates the special mode and resets the success number.

The jump control unit 55 and the acceleration control unit 56 may, when succeeding in consecutive lumps or consecutive accelerations during the special mode, use a special presentation effect, such as a sound effect, a display effect, or the like, that is different from those of normal mode, etc. In addition, when failing in consecutive jumps or consecutive accelerations, the jump control unit 55 and the acceleration control unit 56 may output a voice or display indicating the failure. For example, the jump control unit 55 and the acceleration control unit 56 may use a presentation effect such that the character utters a voice of chagrin, may show a facial expression of chagrin, etc.

If the consecutive success number reaches or surpasses a predetermined value, the jump control unit 55 and the acceleration control unit 56 may change the first requirement or the second requirement to a more severe one. For example, inputting operations may be replaced with more difficult inputting operations, such as, pressing the button greater than or equal to a predetermined time period in order to accelerate or to allow jumping. Alternatively, the number of vertices of a character that contact she ground may be increased, or the time period after getting down on the ground before inputting the operation may be set shorter. This enables the adjustment of the difficulty level of game.

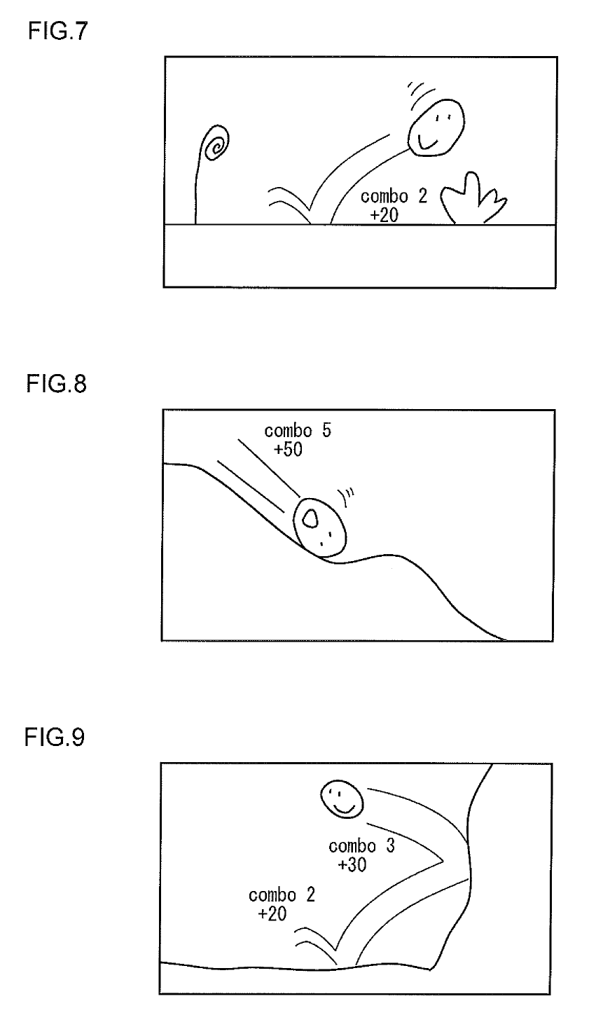

FIG. 7 shows an exemplary screen image of the game where consecutive jumps are successful. Upon succeeding in consecutive jumps, the jump control unit 55 displays the trajectory of the jump in a different display style from that of a normal jump. For example, the trajectory of consecutive jumps may be displayed as broader or longer than that of normal jumps or may be displayed in different colors from that of normal jumps. Further, the jump control unit 55 displays a score to be added as she consecutive success number or bonus points on the game screen image.

FIG. 8 shows an exemplary screen image of the game when successful in consecutive accelerations. Upon succeeding in consecutive accelerations, the acceleration control unit 56 displays the trajectory of the movement in a different display style from that of normal acceleration. Further, the acceleration control unit 56 displays a score to be added as a consecutive success number or as bonus points on the game screen image.

FIG. 9 shows an exemplary screen image of the game when a wall jump is successful. Upon succeeding in wall jumps in the special mode, the lump control unit 55 displays the trajectory of the tamp in a different display style from that of a normal jump. Further, the combo control unit 57 also counts the number of successful wall jumps as the consecutive success number.

In this fashion, simple and easy-to-understand rules, i.e., adding a gradient to the ground and rolling the character to a goal, which bear close resemblance to an old rolling coin game, are adopted. Therefore, amiable and friendly game properties that are acceptable to a wide range of people can be implemented. In addition, a reward is given to a player when she jumps or accelerations are successful in a row. Thus, enjoyment of a game can be improved.

According to the embodiment, an operation rule is adopted where an operation of adding a gradient to the ground makes a character move and operation of accelerating a character increases the moving velocity of the character. In another example, another operation rule may be adopted were a first operation allows a character to move regularly and a second operation allows a character to move at a higher speed. For example, while pressing a predetermined button, a character may be moved at higher speed. In this case, the second operation corresponds to the operation that accelerates a character. Further, although in the embodiment it is the ground or a wall that flips a character and makes the character jump, a game device or program can be configured so thou the character kicks the ground or wall in order to jump by itself.

The description of the invention given above is based upon one illustrative embodiment. This embodiment is intended to be illustrative only, and it will be obvious to those skilled in the art that various modifications to constituting elements and processes could be developed and that such modifications are also within the scope of the present invention,

What is claimed is:

1. A program embedded in a computer readable medium, comprising:
a movement module operative to allow a character to move on a game field;
a jump module operative to receive an input operation for allowing the character to jump and to al low the character to jump;
an acceleration module operative to receive an input operation for accelerating the character while the character is moving and to accelerate the character in the moving direction;
a jump-and-change-mode module operative, after accelerating the character or after allowing the character to jump, if receiving the input operation for allowing the character to jump while a first requirement is satisfied, to allow the character to jump and to change a mode of a game to a special mode where a reward is given to a player;
an accelerate-and-change-mode module operative, after accelerating the character or after allowing the character to jump, if receiving the input operation for accelerating the character while a second requirement is satisfied, to accelerate the character and to change the mode of the game to the special mode where a reward is given to the player;
a terminate module operative, if no input operation for allowing the character to jump is received while the first requirement is satisfied and no input operation for accelerating the character is received while the second requirement is satisfied, to terminate the special mode; and
a reward-giving module operative to give the reward to the player in the special mode.

2. The program according to claim 1, wherein the first requirement includes:
a predetermined period of time is not elapsed after the character contacts a ground;
a parameter indicating the level of contact between the character and the ground is equal to or greater than a predetermined value; or
the character is moving at a speed equal to or greater than a predetermined value.

3. The pro ram according to claim 1, wherein the second requirement includes that the character is moving at a speed equal to or greater than a predetermined value.

4. The program according to claim 1, further comprising
an inclination module operative, on a game field including vertical features, to receive an input operation for adding an inclination to a ground with which the character has contact, and to control the gradient angle of the ground based on the received input operation, wherein
the movement module that controls the movement of the character allows the character to move as if the character rolls or slides on the ground if the gradient angle of the ground is equal to or larger than a predetermined value.

5. The program according to claim 4, wherein the first requirement or the second requirement includes that the character is moving on the ground or a wall of which the gradient angle is equal to or greater than a predetermined value.

6. The program according to claim 4, wherein if the jump module receives the input operation for allowing the character so jump when the character in the special mode jumps and then the character has contact with the wall having a gradient angle equal to or more than a predetermined value, the jump module controls the character so chat the character is flipped by the wall and jumps.

7. The program according so claim 1, wherein the reward-giving module counts the number of successes in allowing the character to lump or in accelerating the character during the special mode, and gives a reward to the player according to the number.

8. The program according to claim 7, wherein the change-mode modules that change the mode of the game to the special mode changes the first requirement or the second requirement to a more severe requirement if the number of successes reaches or surpasses a predetermined value.

9. The program according to claim 1, wherein the input operation for allowing the character to jump and the input operation for accelerating the character are the same input operation, and the program further comprising:
a determining module, when receiving the input operation, determines whether to allow the character to jump or to accelerate the character in accordance with an attribute set for a ground or a wall with which the character has contact.

10. A game device comprising:
a movement control, unit operative to allow a character to move on a game field;
a jump control unit operative to allow the character to jump if an input operation for allowing the character to jump is received, and after accelerating the character or after allowing the character to jump, upon receiving an input operation for allowing the character to jump while a first requirement is satisfied, to allow the character to jump and to change the mode of a game to a special mode where a reward is given to a player;
an acceleration control unit operative, upon receiving an input operation for accelerating the character when the character is moving, to accelerate the character in the moving direction, and after accelerating the character or after allowing the character to jump, upon receiving the input operation for accelerating the character while a second requirement is satisfied, to accelerate the character and to change the mode of the game so she special mode where a reward is given to the player;
a determining unit operative, if no input operation for allowing the character to jump is received while the first requirement is satisfied and no input operation for accelerating the character is received while the second requirement is satisfied, to terminate the special mode; and
a combo control unit operative to give the reward to the player in the special mode.

11. A game controlling method, comprising:
allowing a character to move on a game field;
receiving an input operation for allowing the character to lump, and allowing the character to lump;
receiving an input operation for accelerating the character when the character is moving, and accelerating the character in the moving direction;
after accelerating the character or after allowing the character to jump, upon receiving the input operation for allowing the character to jump while a first requirement is satisfied, allowing the character to jump and changing the mode of a game to a special mode where a reward is given to a player;
after accelerating the character or after allowing the character to jump, upon receiving the input operation for accelerating the character while a second requirement is satisfied, accelerating the character and changing the mode of the game to the special mode where a reward is given to the player;
if no input operation for allowing the character to jump is received while the first requirement is satisfied and no input operation for accelerating the character is received while the second requirement is satisfied, terminating the special mode; and
giving the reward to the player in the special mode.

12. A computer readable medium encoded with the program according to claim 1.
